(19) United States
(12) Patent Application Publication
(10) Pub. No.: US 2006/0288527 A1
(43) Pub. Date: Dec. 28, 2006

(54) Security door/window stop

(76) Inventor: Garry Van Vliet, Stuart, FL (US)

Correspondence Address: KEVIN PETER REDMOND;PATENT ATTORNEY, 6960 SW GATOR TRAIL, PALM CITY, FL, 34990, US

(21) Appl. No.: 11/167,053

(22) Filed: Jun. 27, 2005

(51) Int. Cl. E05F 5/02

(52) U.S. Cl. 16/82

(57) ABSTRACT

A door stop formed of a suction cup attached to body, typically formed of a block of material such as clear plastic, which may be used to lock sliding glass doors and windows in either a closed or in a partially open position. The suction cup will hold to the glass for up to 3 months and dual suction plugs may be used for added security. The body is designed to tip and press the suction cup down to prevent sliding and thereby hold the stop assembly in place even when a strong horizontal force is applied. The body contains an alarm to discourage intruders in the event that the stop is dislodged from the door.

### BACKGROUND

1. Field

The present invention relates to door stops and more particularly to such stops that employ suction cups allowing them to be installed instantly without the use of tools, especially on glass doors and windows.

2. Prior Art

The following is a list of patents which are either related to door stops or suction cups or a combination of both.

U.S. Pat. No. 4,084,290 illustrates a stop for limiting the upward movement of closures such as slidable windows and doors. However, it fails to use suction to hold a window or door in a closed or open position.

U.S. Pat. No. 5,087,005 illustrates a suction cup assembly for securing a device to a surface. However, it is not used to hold a window or door in a closed or open position.

U.S. Pat. No. 5,104,077 illustrates a suction device. However, it is not a device used to hold a window or door in a closed or open position.

U.S. Pat. No. 5,288,257 illustrates an elongate flexible body with suction cups for securing the body to opposed sides of a door member to prevent closing of a door. However, it is not used to hold a window or door securely in a predetermined fixed open or closed position.

U.S. Pat. No. 6,155,009 illustrates a locking security system and method for protecting the glass in windows and doors using suction cups. However, it fails to use the cups to hold a window or door in a closed or open position.

None of the above prior art patents provide a single device which can be installed quickly and function as a door or window stop or provide a decorative identification of their being a glass panel present. These and other short comings of the prior art are overcome by the present invention which is described below.

### BRIEF DESCRIPTION OF THE DRAWINGS

FIG. 1 is a side view of a stop assembly consisting primarily of a body and a suction cup.

FIG. 2 is a top view of the stop assembly of FIG. 1 showing a quick disconnect tab.

FIG. 3 is a side view of the stop assembly of FIG. 1 tipped to one side by a lateral pushing force.

FIG. 4 is a side view of the stop assembly with a projection extending from the body down to the suction cup to prevent the cup from sliding when a lateral force is applied.

FIG. 5 is a side view of the stop with a truncated conical body used for decorative and safety purposes.

FIG. 6 is a side view of a two panel sliding glass door with two door stop assemblies applied to the door, one to prevent unwanted opening and the other to show a pane of glass is present.

FIG. 7 is a side cross-sectional view of the stop showing a variation of the invention in which a cavity made in made in the body to house an alarm.

FIG. 8 is a top view of the body shown in FIG. 7 with a cover over the cavity.

FIG. 9 is a side view of a mercury level switch used to detect the position of the stop and initiate an alarm if the stop is dislodged from a door.

FIG. 10 is a block diagram of the alarm system.

### SUMMARY

It is an object of the present invention to provide a stop assembly that can be used on a door or a window to prevent its being opened.

It is an object of the present invention to provide a stop assembly that can be used with partially opened doors and windows to prevent their being opened further.

It is an object of the present invention to prevent the sliding of the suction cup when a lateral force is applied.

The present invention is a door stop formed of a suction cup attached to a body which is typically formed by a block of material such as clear plastic. The door stop may be used to lock sliding glass doors and windows in either a closed or in a partially open position. The suction cup will hold to the glass for up to 3 months and dual suction plugs may be used for added security. The body is designed to tip and press the suction cup down to prevent sliding and thereby hold the stop assembly in place even when a strong lateral force is applied.

To apply the stop assembly, it is simply squeezed against a surface such as the fixed glass panel near the center column of a two glass panel door. When an attempt is made to open the moveable panel of the door, it will hit the stop assembly and be prevented from opening.

The body of the stop assembly may carry a projection that is forced downward when a lateral force is applied, preventing the suction cup from sliding laterally and thereby providing a better stopping action than the suction cup alone.

An alarm built into the body detest if the stop is dislodged from the door.

### DETAILED DESCRIPTION OF THE INVENTION

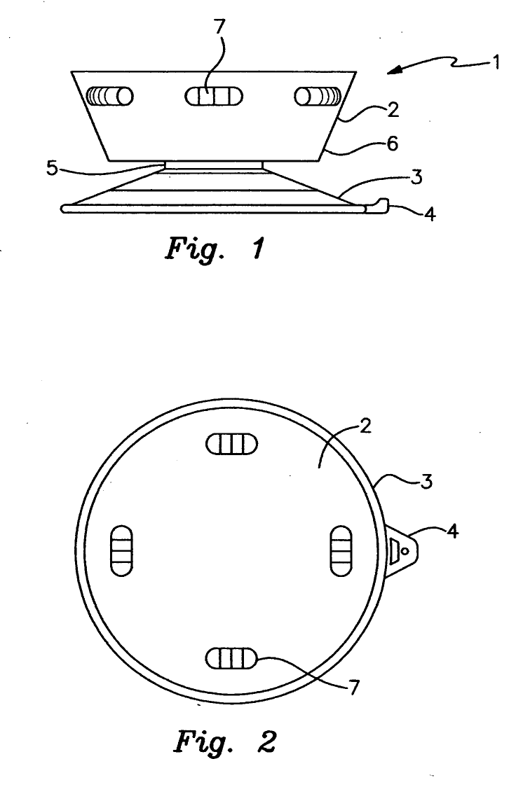

FIG. 1 is a side view of a stop assembly consisting of a body 2 and a suction cup 3. The cup has a concave shape where the outside of the raised portion in the concave shape is referred to as the pressure side and the opposite side is referred to as the suction side. The cup has a pressure side 33 and a suction side 34. The body is connected to the cup by way of a connection section 5. At the edge of the suction cup is a quick release tab 4. This tab may be lifted up which lifts up the edge of the cup to allow air into the cup dissolving suction beneath the cup and allowing the cup to be easily removed from the panel. About the lower edge of the body 6 is a corner which contacts the cup when the body is pressed laterally. In the use of the stop assembly 1, the body 2 is pressed downward on the pressure side 33, forcing air out of the suction cup 3 from the suction side 34 causing it to adhere on the suction side to whatever surface it has been placed against, typically a panel of glass such as a glass panel in a door.

The body has a central axis 35 and bottom side 36 which is the side that faces the pressure side of the cup. The bottom side 36 is typically orthogonal to the central axis of the body 35.

FIG. 2 is a top view of the stop assembly showing the quick disconnect tab 4. Typically, both the body and the suction cup are circular in plan view. The body may be made of clear plastic and can contain decorations such as shells, indicated by drawing numeral 7. Lifting the tab breaks the seal of the cup to a panel, making its removal easy.

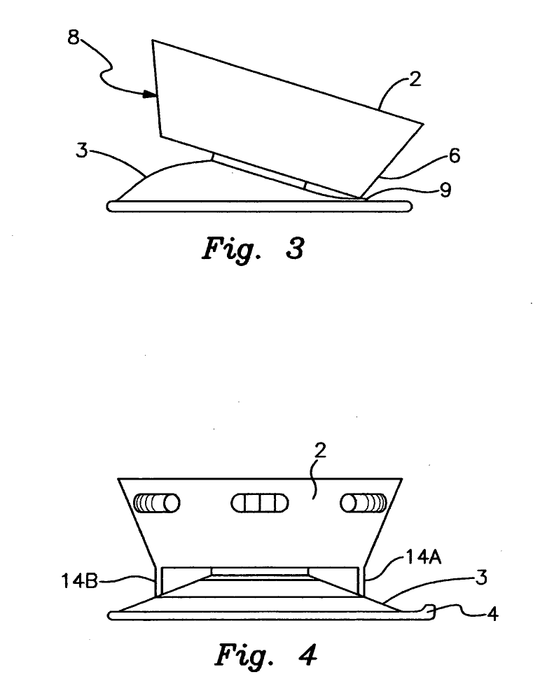

FIG. 3 is a side view of the stop assembly tipped to one side by a lateral pushing force 8. The edge 6 of the lower side of the body is now pressed up against the suction cup at point 9. The pressure at this point tends to prevent the suction cup from being slid across the surface, even though it is held to it by the suction cup. Although this added holding force is not normally necessary, it does improve the locking ability of the stop assembly to the surface to which it is attached.

FIG. 4 is a side view of the stop assembly with first projections, such as 14A or 14 B, extending from the body down to the suction cup. These projection do the same thing as edge 6 only the body does not need to be tipped as far When a lateral force is applied such as force 8, it tends to tip the cup and these projections dig into the suction cup, pinning it to the surface to which it is attached and thereby preventing it from moving sideways or being dislodged.

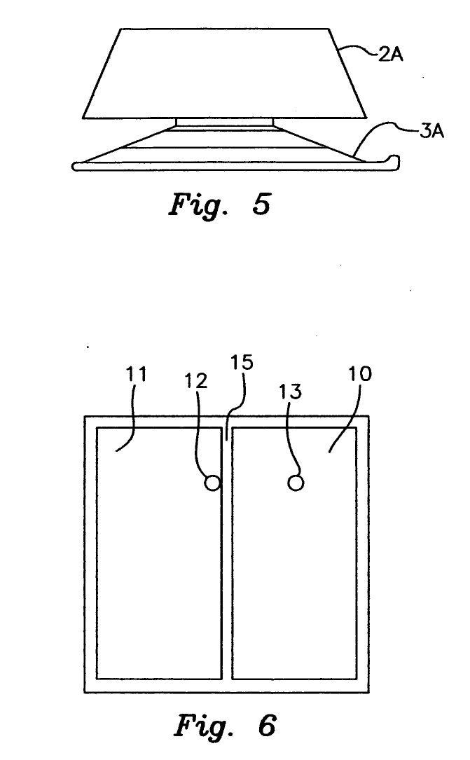

FIG. 5 is a side view of a stop assembly with a truncated conical body used for decorative and safety purposes. The top of the body 2A has a conical shape and it is supported by a second suction cup 3A located beneath it.

FIG. 6 is a side view of a two panel sliding door with two door stop assemblies applied to the doors. One to prevent unwanted opening and the other to show a pane of glass is present. The two door assembly has a sliding door 10 to the right and a fixed panel door 11 to the left. Adjacent to the center column 15 is a door stop assembly 12. When an effort is made to open the sliding glass panel 10, the door stop 11 prevents its movement because of its position up against the column 15. On the moveable glass panel near its center is a second door stop 13 used for decorative purposes and safety purposes. When placed in the center panel in this fashion, it prevents the glass panel from appearing like an open door and thereby prevents people from walking into the glass. In this way, the stop assembly becomes a decorative as well as a safety device.

FIG. 7 is a side cross-sectional view of the stop showing a variation of the invention in which a cavity is made in the body to house an alarm. In this Figure a cavity 16 is made in the body 2 to house an alarm 17, a battery 37 and a level detector or level switch 21. The cavity is open at its top to provide access to the alarm. The cavity has a bottom 19 on which the alarm 17 rests and cavity wall 18 which surrounds the alarm.

FIG. 8 is a top view of the stop showing a top view of the invention shown in FIG. 7 with a cover 20 placed over the cavity to protect the alarm and to carry a mark 32 to show the up position for the stop. The mark has an upward position for the stop. The mark has an arrow which is to be placed in the vertical position and a line which should be positioned horizontally.

FIG. 9 is a side view of a mercury level detection switch 25 used to detect the position of the stop and to initiate an alarm if the stop is dislodged from a door. The switch comprises a tube 22 usually made of glass which is sealed at both ends and is partially filled with mercury 25. The tube has two contacts 23 and 24 which pass through the glass to where they may be contacted by the mercury within the tube. The glass is sealed to the contacts to prevent the mercury from escaping from the tube.

The contact 24 is lower on the tube than contact 23. With the tube in a vertical position as shown in FIG. 9, contact 24 makes electrical contact with the mercury in the tube, while contact 23 is above and not in contact with the mercury.

The contact both encircle the glass on the inside so that no matter how or in what direction the tube is tipped from the vertical axis both contacts will be in contact with the mercury and will provide a continuous path for electrical current.

In the operation of the mercury level switch, there will be no electrical path through the switch unless the switch is inclined away from its vertical position as shown in FIG. 9. The switch is placed in its vertical position as shown in FIG. 9 in the cavity 16 and the markings 32 are used to aid in directing how the stop is to placed on a panel or door. When so placed the level switch is opened and will not activate an alarm.

In this position, no current will flow through the switch, even if it is connected in series with a battery 37 shown in FIG. 7. However, if the stop is dislodged from the door, for any reason, the switch will be closed because contact 23 will be in contact 24 by way of the mercury cavity for the alarm to go off. This will alert a home owner to the fact that there has been an intrusion on to the premises or the stop has to be re-positioned on the door to continue protection of the premises.

To prevent the stop from inadvertently falling to a position where the switch is vertical and does not close the electrical path through the switch, a projection 31, shown in FIG. 8 is added to cause the stop to roll to a position where it will close the switch in every case.

The alarm may be a simpler buzzer built into the cavity which will be heard by intruders and owner alike, possibly deterring the intruder from any further into the house. However, a more sophisticated alarm system is shown in FIG. 10. FIG. 10 is a block diagram of such an alarm system. This Figure includes the level detector 27, a latching relay 26, a local alarm 27, a radio transmitter 28, a remote receiver/alarm 29 and a remote receiver/silent alarm 30.

In the operation of the system shown in FIG. 10. The level detector 21 detects when the stop has been dislodged from a door and sends a signal to the latching relay 26 which locks itself in an on or alarm position on receiving the signal from the level detector 21. The latching relay sends a signal to one of any number of alarms depending on the particular type of alarm system being used.

The first and most simple is an alarm built into the body of the stop which produces an audio sound such as a buzzer. The audio sound may also be that of a siren produced by an audio oscillator and a speaker. The alarm may be pulsated to emphasize its presence and reduce power consumption from the self contained square wave generator within the body which alternatively turns the alarm on and off. This alternation may be produced by opening and closing the latching relay which is driven by the square wave oscillator.

Two other alternatives for the alarm system is the use of a radio transmitter 28 within the alarm to send a wireless signal to a remote audio alarm receiver 29 or a silent alarm receiver 30. The audio alarm receiver produces an audio alarm at a remote location, usually one that is not easily accessible to an intruder. The remote station is typically provided with its own latching relay to prevent the alarm from shutting down because of battery exhaustion in the stop transmitter.

The silent alarm includes a remove receiver that is used to activate a silent alarm, such as a flashing light, so that an intruder will not know that his entrance has been detected, or it can be used to automatically telephone a remote location to let a home owner know that there is a burglary in process at his home.

I claim:

1. A stop which includes a suction cup, said cup having a suction side and a pressure side and said cup being applied by suction to a panel to stop said panel from being moved beyond a selected point.

2. A stop as claimed in claim 1, further comprising a body, said body being attached to said cup on its pressure side.

3. A stop as claimed in claim 2, wherein said body has a central axis and a bottom side which is generally orthogonal to said axis and faces said pressure side of said cup, said stop further includes a plurality of first projections which are attached to said bottom side of said body, said plurality of first projections being positioned away from said central axis and directed towards said suction cup, and said projections applying pressure against said cup when a lateral opening force is applied to said body.

4. A stop as claimed in claim 1, wherein said cup has a center and a generally circular periphery, said cup further including a quick disconnect tab attached to the periphery of said cup and extending radially outward from said center to provide a means for lifting the edge of the cup to allow air to enter said cup and dissolve the suction force beneath said cup, said tab permitting the easy removal of the cup from a panel.

5. A stop as claimed in claim 2, further comprising a cavity and within said cavity a battery and a level switch, said battery being connected to said level switch and said level switch being positioned on a panel to place said level switch in an open position when on said panel and to be placed in a closed position when dislodged from said panel and dropped to the floor.

6. A stop as claimed in claim 5, further comprising a second projection attached and extending from a side of said body to prevent said level switch from being in an open position when dislodged from a panel and dropped to the floor.

7. A stop as claimed in claim 6, wherein said stop further comprising an alarm located in said cavity and connected to said switch and battery to activate said alarm when said stop switch is dislodged from a panel and dropped to the floor below the panel.

8. A stop as claimed in claim 6, wherein said stop further comprises a radio transmitter connected to said level switch and to said battery to activate said transmitter to emit a radio signal when said stop is dropped to the floor below said panel.

9. A stop as claimed in claim 8 further comprising a receiver which is designed to receive the signal from said stop and activates a second alarm at a location remove from said stop.

10. A stop as claimed in claim 9 wherein said second alarm is an audio alarm.

11. A stop as claimed in claim 7 wherein said second alarm is a silent alarm.
